(19) United States
(12) Patent Application Publication
(10) Pub. No.: US 2018/0158309 A1
(43) Pub. Date: Jun. 7, 2018

(54) Sound-responsive Repeater Device and System

(71) Applicant: Karl Michael Steins, San Diego, CA (US)

(72) Inventor: Karl Michael Steins, San Diego, CA (US)

(21) Appl. No.: 15/805,035

(22) Filed: Nov. 6, 2017

Related U.S. Application Data
(60) Provisional application No. 62/417,839, filed on Nov. 4, 2016.

(51) Int. Cl. G08B 25/00; G10L 25/51; G08B 25/10

(52) U.S. Cl. CPC G08B 25/009; H04R 1/028; G08B 25/10; G10L 25/51

(57) ABSTRACT

A Sound-responsive Repeater Device, System, and Method. The device can be programmed to recognize audible sounds and then responsively trigger an action. The triggered actions are local visual and audible alerts, such as flashing lights and audible sirens or beeps. Each device may be capable of recognizing the unique alert tone of another device so that each device will trigger on the audible alert being generated by another device without the need for user programming. This will create a “domino effect” of cascading alerts from device to device. Each device will have onboard backup power, as well as at least one removeable flashlight that will provide a user with emergency lighting at each device, and the ability to take a flashlight with them in order to escape the building. There will be versions of the device that interconnect with conventional Home Automation gateways, either via conventional Home Automation communications protocol (e.g. zigbee, zwave, etc.), or by WiFi. These interconnected devices should not only be able to generate triggers for the HA gateway, but they should also be able to receive Home Automation triggers from the gateway. Receipt of these triggers should generate audible and/or visual alerts at the devices, depending upon their programming. Each device can be converted from a non-interconnected to an interconnected mode by exchanging a detachable module, such as the flashlight module, with an interconnectable module.

This application is filed within one year of, and claims priority to Provisional Application Ser. No. 62/417,839, filed Nov. 4, 2016.

### BACKGROUND OF THE INVENTION

### 1. Field of the Invention

This invention relates generally to wireless automation systems and, more specifically, to a Sound-responsive Repeater Device. System, and Method.

### 2. Description of Related Art

Home Automation (“HA”) or wireless automation technology has experienced a developmental explosion in recent years. The field includes a series of sensors and devices that can be monitored and/or controlled remotely, such as light switches, outlets, door and window sensors, remotely-operable locks, smoke detectors, video cameras, remote-controlled thermometers.

There are generally two basic types of HA systems: those that employ a local gateway, and those that employ a cloud gateway. The main distinction between the two types being where the gateway is phystically located, and whether the individual sensors and devices communicate with the gateway via a local wired/wireless or combination network, or whether the sensors and devices communicate directly over the world wide web with the cloud-based gateway. While the local gateway system has the added cost of a gateway, there is also the benefit of being able to design sensors that can be battery-powered, since they can consume very small amounts of power. In contrast, it appears to be common that all devices and sensors in a cloud-gateway system require an external, continuous power source (i.e. they plug into the wall). To date, the trend toward the local gateway network is greatly outnumbered that of the cloud gateway.

In the world of local gateway automation systems, there has been a failure for the industry to standardize the protocol for the different devices to communicate with each other and with the gateway. X10 technology is a very early form of automation that utilizes the actual power lines for such communication. As new systems have evolved, they have tended to focus on wireless RF technology for this communication (although at least one approach—“Insteon (TM)”—appears able to communicate via both powerline and by RF. Two prominent RF protocols in this field are “Zigbee” and “Zwave.” These two protocols are completely incompatible with one another, despite the fact that both employ very similar hardware and software, and are in very similar frequency bands. Since the devices and sensors can only be members of a network employing a single protocol, the system designer is forced to choose. Once a system communications protocol is chosen, only devices and sensors compatible with these standard communciations protocols can be integrated into that user's automation network. Furthermore, some manufacturers have gone so far as to adopt a proprietary RF communications protocol, which has the effect of making the user a hostage of that manufacturer, since the manufacturer will typically not allow any other company to produce compatible devices.

In addition to the problems related to cross-platform incompatibility between HA communications protocols, there is another issue related to legacy sensors and alarms. It would not be much of a reach to assume that virtually every habitable structure has a series of smoke and CO detectors. Many of these detectors/alarms are interconnected to each other so that if one of the devices detects and alarm condition, then all of the alarms will alert. These devices could be connected to one another by wire or by wireless means. While there are HA-enabled smoke and CO detectors, it appears that none of them can be integrated with existing inconnected detector/alarms. Consequently, if a user wished to install HA-enabled smoke and CO detectors, then the existing detectors would no longer be useable. So, in today's HA environment, not only must the user decide to discard perfectly working smoke/CO detectors, but the user will also have to commit to a particular communications protocol.

It would be very beneficial if there were a device that could bridge the divide beween legacy hazard detectors, while also allowing the device to be configured so that it will be compatible with that user's desired HA networking protocol.

### SUMMARY OF THE INVENTION

In light of the aforementioned problems associated with the prior devices and systems, it is an object of the present invention to provide a Sound-responsive Repeater Device and System. The device should be able to be programmed to recognize audible sounds and then responsively trigger an action. The triggered actions should 5 be local visual and audible alerts, such as flashing lights and audible sirens or beeps. Each device should be capable of recognizing the unique alert tone of another device so that each device will trigger on the audible alert being generated by another device. This should create a “domino effect” of cascading alerts from device to device. Each device should have onboard backup power, as well as at least one removeable flashlight that will provide a user with emergency lighting at each device, and also the ability to take a flashlight with them in order to escape the building. There should be versions of the device that interconnect with conventional Home Automation gateways, either via conventional Home Automation communications protocol (e.g. zigbee, zwave, etc.), or by WiFi. These interconnected devices should not only be able to generate triggers for the HA gateway, but they should also be able to receive Home Automation triggers from the gateway. The devices should be convertible from being noninterconnected to interconnected by simply changing outReceipt of thesae triggers should generate audible and/or visual alerts at the devices, depending upon their programming.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a preferred embodiment of the sound-responsive repeater device of the present invention;

FIG. 2 depicts a sample action/reaction chart for the device of FIG. 1 in an integrated HA system;

FIGS. 3A, 3B and 3C are front, side and partial side views, respectively, of the device of FIG. 1;

FIG. 4 is a partially transparent front view of the base module of the device of FIG. 1;

FIGS. 5A and 5B are front views of two versions of the flashlight module of the device of FIG. 1;

FIG. 6 depicts the functionality of the device of FIG. 1 functioning as a standalone device;

FIG. 7 depicts the functionality of a series of devices of FIG. 1 functioning within an HA network;

FIG. 8 is a flowchart depicting a preferred method for configuring the triggers in the device of FIG. 1;

FIG. 9 is a flowchart depicting a preferred method for cascading an alert to a HA network utilizing the device of FIG. 1; and

FIG. 10 is a perspective view of an alternate embodiment of the sound-responsive repeater device of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Sound-responsive Repeater Device and System.

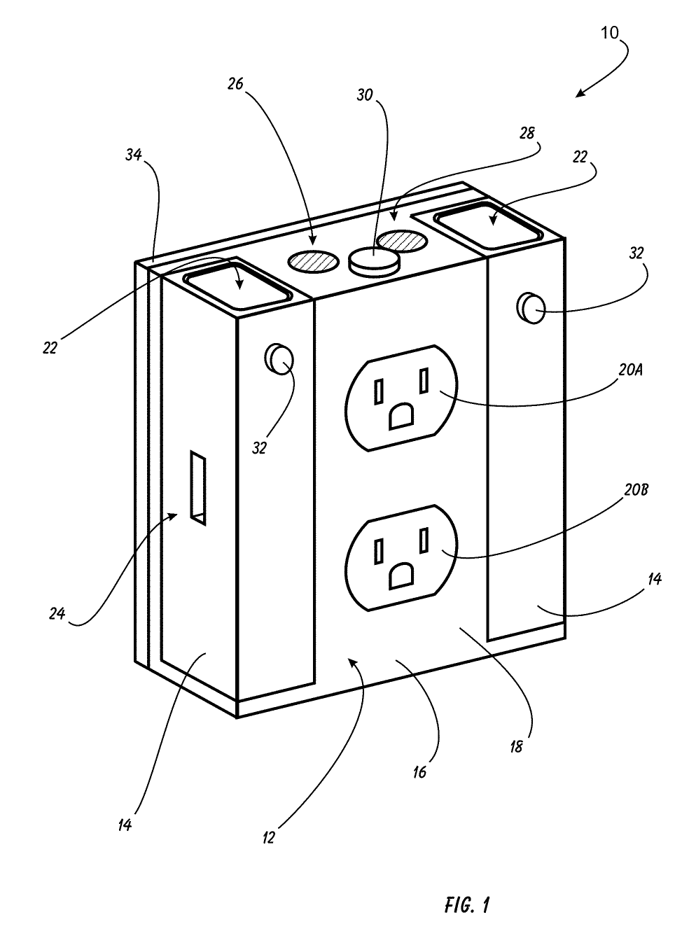

The present invention can best be understood by initial consideration of FIG. 1.¹ FIG. 1 is a perspective view of a preferred embodiment of the sound-responsive repeater device 10 of the present invention. The device 10 is intended to plug into a standard duplex household AC outlet (including versions compatible with worldwide conventions). In its least capable configuration, it will “listen” and will create a user-configured output whenever a pre-configured sound is detected by the device 10. This could be as simple as the device 10 creating an audible and visual output when it detects that a smoke detector is generating an alert. With its extensive programmability and capability for integration, the device 10 can provide much, much more. ¹ As used throughout this disclosure, element numbers enclosed in square brackets [ ] indicates that the referenced element is not shown in the instant drawing figure, but rather is displayed elsewhere in another drawing figure.

The device 10 has a base module 12 and one or more detachable (optionally) flashlight modules 14. When the flashlight modules 14 are plugged in to the base module 12, they can be controlled by the base module 12 (they can be turned on and off by the base module 12). Each module 14 may also have a button 32 on it so that the user can turn on and off the light when the module 14 is removed.

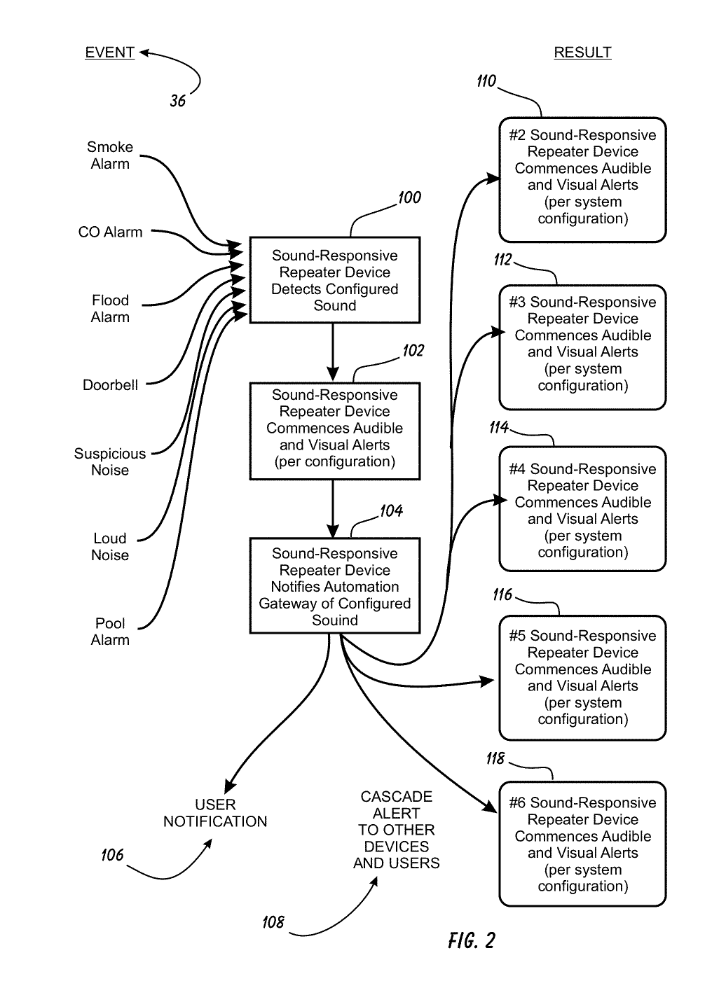

The base module 12 is defined by a base housing 16 that has power outlets 20A, 20B on its face 18. These power outlets 20A, 20B may be automated (i.e. controllable via the Home Automation system). A rear portion of the module 12 may be made from a clear lens 34. In fact, here, the back plate is a piece of polycarbonite or other clear plastic. The lens 34 can be lit by an internal lamp controlled by the module 12, if the user configures the device 10 to react in this manner. The device 10 has a microphone element 28 and a speaker element 26 within the housing 16. As should be apparent, these elements 26, 28 function to detect sounds and then to emit sounds, as user-configured. One or more buttons 30 may be provided on the base module 12 in order to provide user interaction with the device 10 (such as to silence an alarm). The flashlight modules 14 each have a lamp 22 (most likely an LED), and can be removed from the base module 12. The modules 14 may also have USB sockets 24 that allow the user to charge their portable electronic devices, as well as to program the base module 12 (i.e. to configure the module's triggers and responses). FIG. 2 illuminates the way in which the device 10 operates.

FIG. 2 depicts a sample action/reaction chart for the device [10] of FIG. 1 in an integrated HA system. When a device [10] detects a sound that has been pre-configured by the user 100, it will commence audible and visual alerts 102 according to its configuration.

If the device is HA-enabled, it will notify the HA gateway that the configured sound has been detected 104. This is sometimes referred to as a “trigger” for the HA gateway. This trigger could provide user notification 106 (locally or through the gateway), but it can also be used to cascade the alert/trigger to other devices and users 108. Because they are HA-enabled, each device [10] can be controlled by the gateway so that devices [10] 2, 3, 4, 5, 6 and others begin to emit alerts such as audible or visual alerts (steps 110, 112, 114, 116 and 118). For example, the first device [10] (i.e. the one that first detects the audible sound for which it has been configured) detects a smoke alarm. The device [10] may begin to transmit a smoke alarm sound (presumably similar to the detected sound), while also illuminating/flashing the lamps [22] and the back plate lens [34] (lit by a lamp built into the base module [12]. Soon thereafter, devices [10] 2-6 would begin transmitting a smoke alarm sound while also illuminating/flashing the lamps [22], etc.. The end result is that the entire network of devices [10] would behave as if they were interconnected to the original smoke alarm, without the need for discarding the legacy non-interconnected smoke alarms. And of course the users now have a emergency flashlight or two (the flashlight modules [14]) that can be removed from the base module 12 so that everyone present can safely escape the buildings.

The events 36 could be as common as an alert emanating from a smoke detector, CO detector, Flood alarm or Pool perimeter alarm. The events could also be a little more novel—a doorbell, breaking glass, some other suspicious noise (according to a pre-loaded set of audio profiles), or a noise above a certain loudness level. These are only examples of sound events 36; any sound that can be recognized by the device [10] can be used to create a response 102, 104.

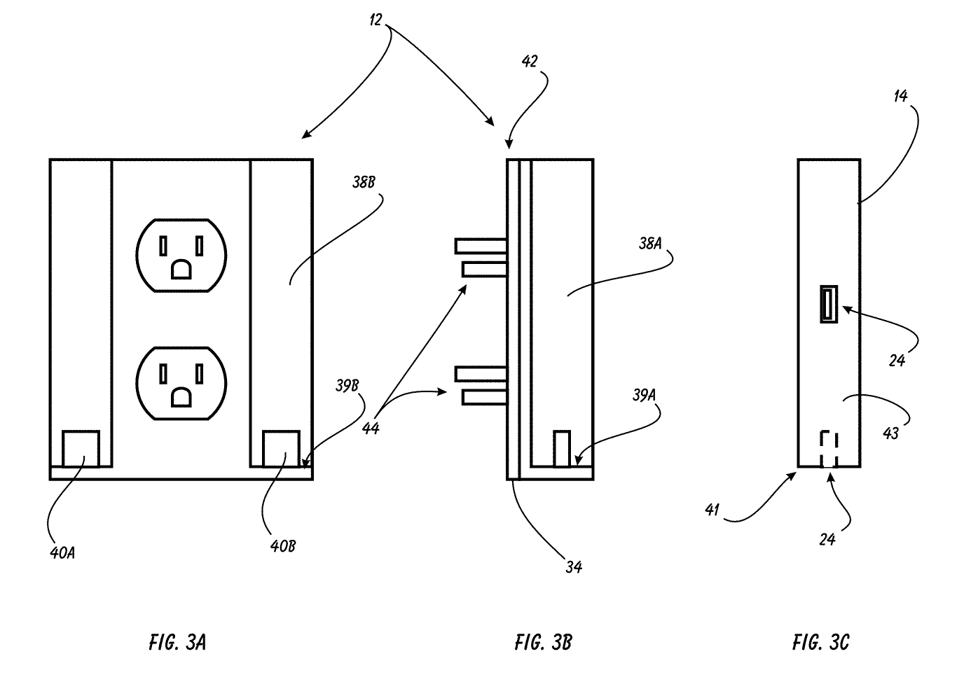

FIGS. 3A, 3B and 3C are front, side and partial side views, respectively, of the device 10 of FIG. 1. In FIGS. 3A and 3B, the flashlight modules 14 have been removed from their holsters 38A, 38B in the base module 12. To remove the modules 14, the user needs only to pull up on the modules 14 until they come free from the USB plugs 40A or 40B protruding from the bottom walls 39A, 39B of the holsters 38A, 38B. Removing the flashlight module 14 from a holster 38A or 38B may cause the lamp [22] in the module 14 to light up (depending upon the user's desired configuration).

In FIG. 3B, we can see the backplate lens 34 from the side. As discussed above, a rear lamp 42 could be positioned within the lens 34 so that the edges of the lens 34 will light up when the rear lamp 42 is lit. As also shown, prongs 44 are configured to insert into a conventional AC power outlet to provide power to the module 12, as well as to retain the module 12 in place.

Each flashlight module 14 has a USB socket on its bottom 41 for interface with one of the USB plugs 40A, 40B. There is also a USB socket 24 on the side 43 of the modules 14. The side socket 24 can be used to connect a standard USB cable to program the base module 12, as well as to simply re-charge a portable device (i.e. when the module 14 is plugged into a USB plug 40A, 40B in the base module 12.

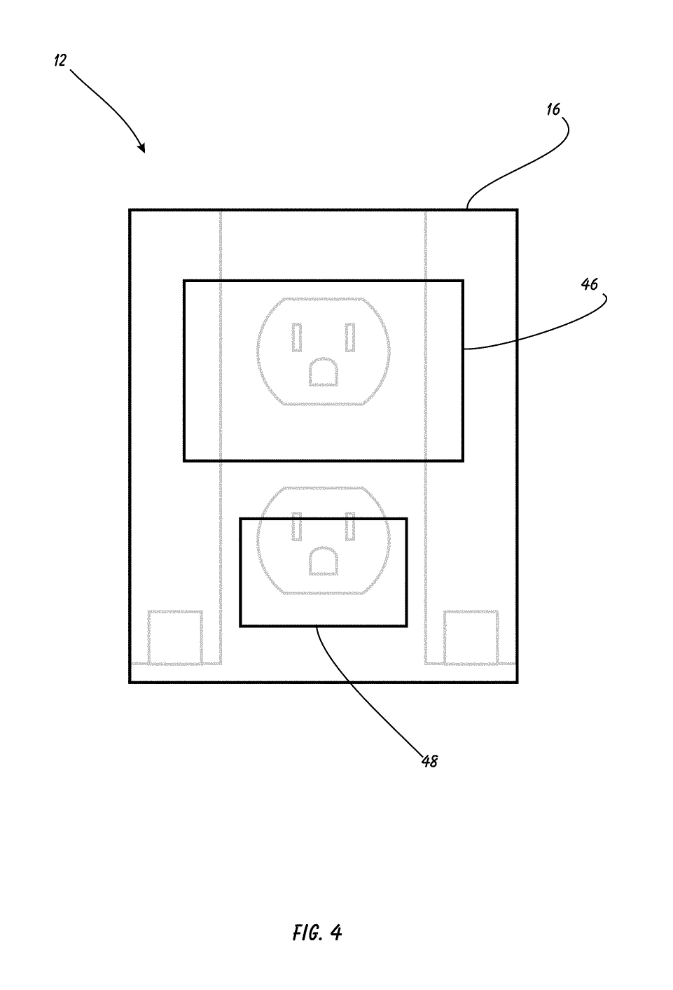

FIG. 4 is a partially transparent front view of the base module 12 of the device [10] of FIG. 1. This is presented so that we can see that the housing 16 contains a backup battery element 48 and control system 46. The backup battery 48 provides power to the base module 12 if the AC power supply is lost. This means that the audible and visual alerts will continue being emitted by the base module 12 even in the event of power loss. The control system 46 is the “brains” of the device [10], and is expected to be a electronic circuit or series of circuits that embodies the hardware, software and firmware necessary to provide the functionality discussed within this document. The USB sockets [24] can be used to control, upload to and download from the control system 46.

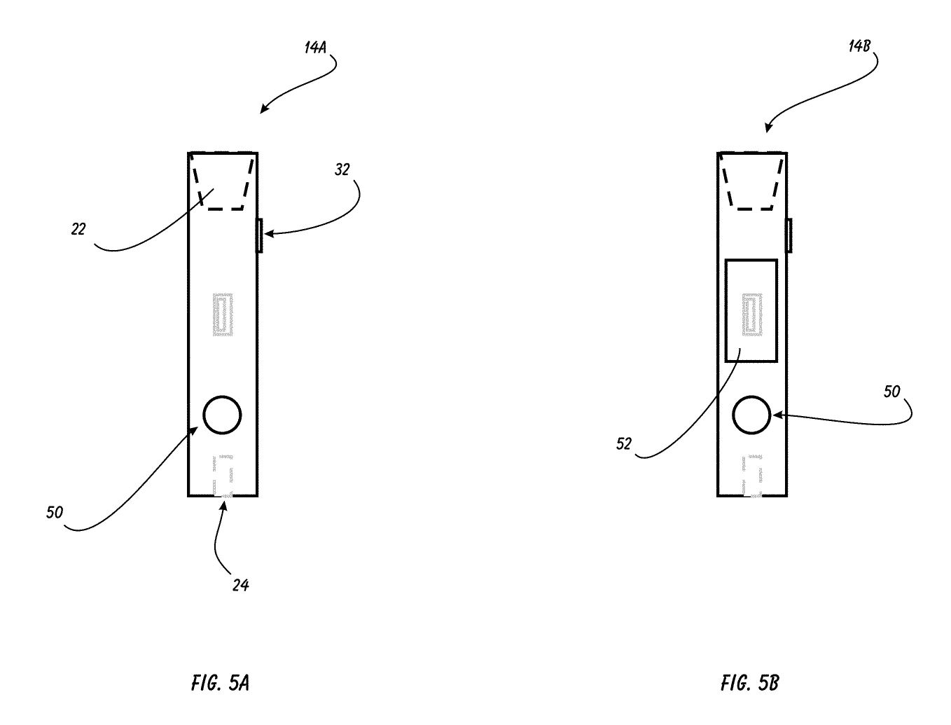

FIGS. 5A and 5B are front views of two versions of the flashlight module of the device of FIG. 1. The basic flashlight module 14A is a basic flashlight that has the added functionality of being controllable via the USB socket [24] to turn off or on (i.e. by the base module [12]). There is a lamp 22 and an internal battery 50. As discussed previously, a button 32 is likely to be provided so that the user can turn the lamp 22 on and off manually.

The interconnected flashlight module 14B has the added component of the internal connectivity subsystem 52. This subsystem 52 provides the hardware, firmware and software to interconnect to a wireless HA network. One standard (non-interconnected) module 14A can be exchanged with a module 14B that includes the connectivity subsystem 52. This modification will allow the module [12] to now connect via WiFi, Zigbee, Zwave or other wireless means with the HA gateway. As such the device [10] can always be made to be compatible with any standard HA communications technology. This means that the user can utilized the devices [10] initially without their being interconnected, and still be able to use them as another HA node at some later date. Consequently, the device [10] will not become obsolete because of a later choice (or change) to a particular HA system technology. In fact, it would even be possible to use the device [10] as a bridge between HA systems of disparate communications technologies by having a device [10] of one HA technology trigger on sound alerts generated by a device [10] that is connected to a network employing a different HA technology.

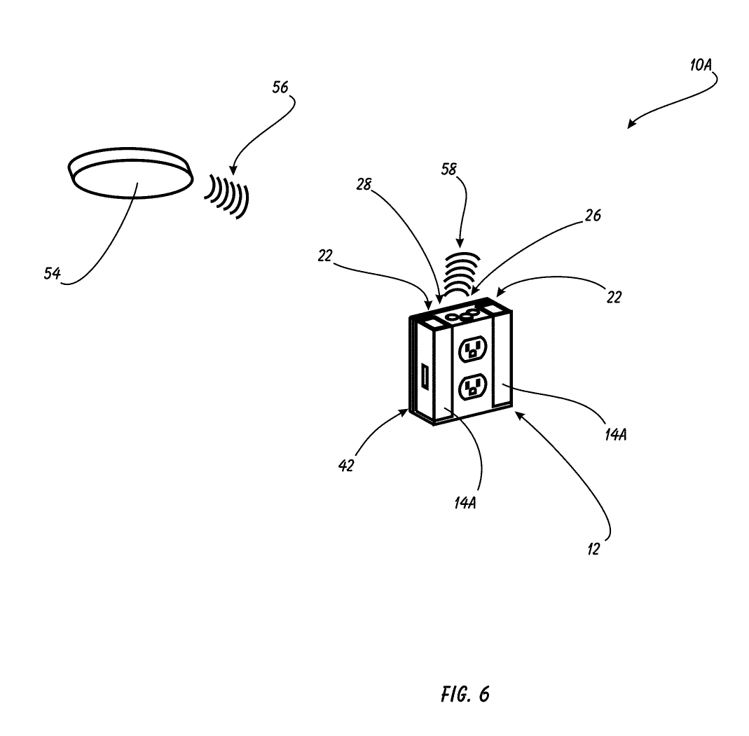

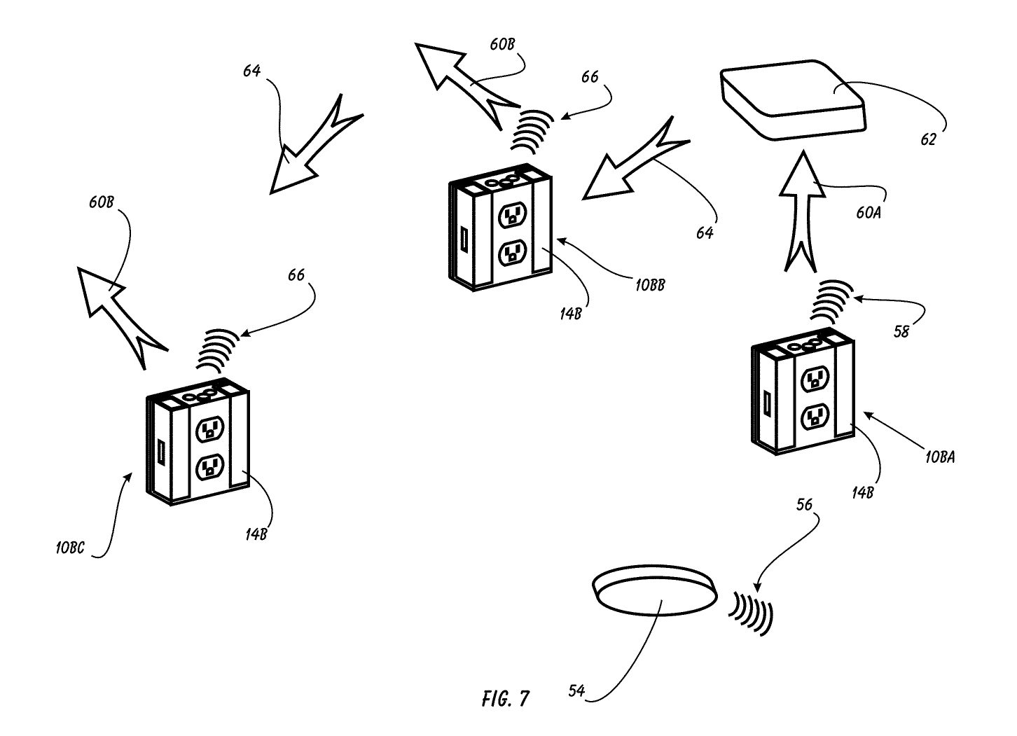

FIG. 6 depicts the functionality of a version of the device 10A of FIG. 1 functioning as a standalone device. This is a non-interlinked version of the repeater device 10A. As such, a pair of non-interconnected flashlight modules 14A are attached to the base module 12. Here, the legacy smoke detector 54 has begun emitting a smoke alert 56. The microphone element 28 in the base module 12 has detected the smoke alert 56. Because the smoke alert 56 has been configured to create a trigger in the device 10A, the speaker element 26 begins to emit the repeated alert 58 (audible), which could be a recording of the smoke alert 56, or it could be a sound that was pre-loaded into the device 10A. The lamps 22 on the flashlight modules 14A would illuminate, and the rear lamp 42 would begin to flash red. Of course, all of these triggered outputs would be the result of the user's choice, but these are the outputs that might be considered to be typical. FIG. 7 depicts the substantial expandability of this basic concept when the devices 10 are interconnected.

FIG. 7 depicts the functionality of a series of devices 10B of FIG. 1 functioning within an HA network. These are interlinked versions of the repeater device 10B. Here, when the smoke detector 54 emits a smoke alert 56, the first device 10BA generates repeated alert 58 (and the other outputs as discussed in connection with FIG. 6). In addition, the device 10BA generates outbound trigger message 60A in the desired form/protocol, as determined by the connectivity subsystem within the devices 10BA-10BC. The connectivity subsystem could be within the flashlight module [14B], or elsewhere within the devices 10BA-10BC.

This trigger 60A is received and processed by the gateway system 62 (whether local or cloud-based), and according to its user programming, now generates inbound trigger message 64. In the case of Z-wave HA protocol, inbound trigger messages 64 are re-transmitted by most Z-wave devices that are members of the particular HA network. In this manner, the inbound trigger message 64 will reach all devices within the HA network—even if they are not within range of the gateway system 62. These messages are not to be confused with outbound trigger messages 60B, which are messages from devices 1OBB, 10BC (and so on) back to the gateway system 62 that inform the system 62 that they have all been triggered by the inbound trigger message 64. Again, in a Z-wave-based system, these outbound trigger messages 60B will also be re-transmitted by each device 10BA - 10BC, etc., until it reaches the gateway system 62.

As each device 10BB, 10BC, etc. receive the inbound trigger message 64, they will each generate triggered alerts 66 (audible and visual alerts as discussed above) as configured by the user. In this fashion, the user can easily extend the reach of any audible alert, essentially without limitation. This is without the need for replacement of any of the legacy devices in the user's system.

It should be understood that we've confined our discussion to the potential for cascading alerts to other devices 10 that are interconnected to the gateway system 62, much more functionality could be provided. For example, HA-interconnected video cameras could begin recording upon receipt of a trigger message 64. HA-interconnected garage doors or door locks could be opened or unlocked. HA-interconnected ariel drone video recorders could be directed to commence a pre-defined flight path while recording video. Once a HA-based trigger message 60A is received by the gateway system 62, all functionality of all HA-interconnected devices can be responsively activated, if programmed by the user.

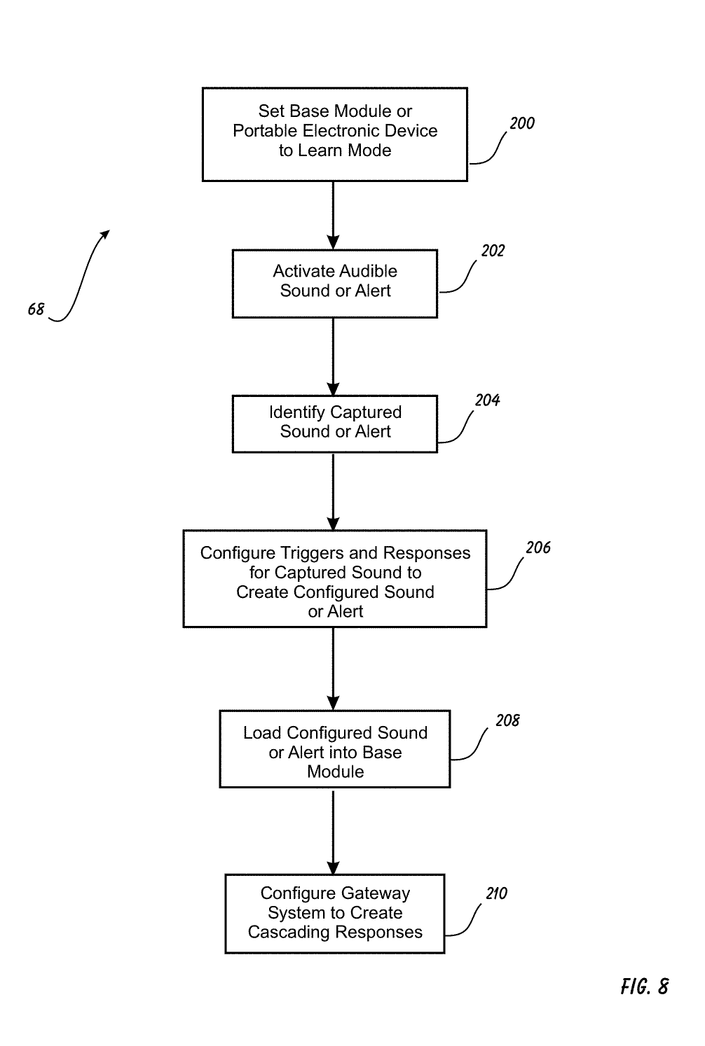

FIG. 8 is a flowchart depicting a preferred method for configuring the triggers 68 in the device of FIG. 1. These steps will be necessary in order that a device [10A or 10B] recognize and react as desired to environmental sounds. First 200, the user must set the base module [12] or an electronic device (e.g. a smart phone having a specialized application installed on it) into “learn mode.” The user then activates the audible sound or alert 202 so that it is “heard” by the base module [12] or electronic device. The user then identifies the captured sound or alert 204 by naming the alert (e.g. “bedroom 1 smoke alarm”). Next, the user configures the triggers and responses for the captured sound 206, including all alerts [58 or 66] and trigger messages [60A or 60B]. The sound or alert is now “configured.” The configured sound is then loaded into the base module [12] (of course, unless the sound was configured within the base module itself). 208.

In order to insure that the device [10] is configured properly, it is expected that the microphone on the device [10] will be used to “hear” the audible sound or alert (i.e. rather than the electronic device's microphone) in order to maximize the reliability that future audible sounds or alerts will be recognized. It will also resolve any attenuation problems due to distance or obstructions between the device [10] and the source of the audible sound or alert (e.g. smoke detector), since the new sound will not be able to be configured unless the device [10] is able to “hear” it.

Communication between the base module [12] and the electronic device could be via the USB connection discussed previously, but it is more likely that this interconnection would be wireless (e.g. bluetooth). A wireless interconnection tends to be more consistent across all hardware platforms (i.e. the electronic device) than is USB or other wired interconnections. This hardware and firmware for this wireless interconnection could be contained within either the base module [12], or even one of the flashlight modules [14 or 14A].

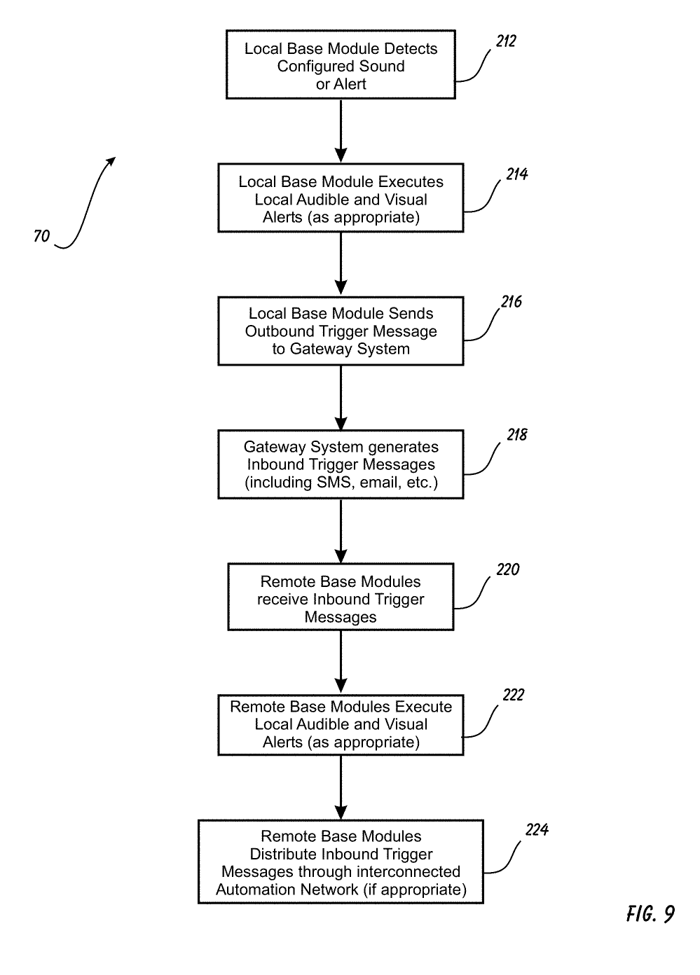

If the device is an HA-interconnected version 10B, then the gateway system must be programmed/configured in order to create the cascading responses 210 discussed above in connection with FIG. 7. Finally, FIG. 9 illuminates how the HA system will react once fully configured/programmed.

FIG. 9 is a flowchart depicting a preferred method for cascading an alert to a HA network 70 utilizing the device [10B] of FIG. 1. When a local base module [10B] detects a configured sound or alert (e.g. smoke alert [56]) 212, the base module detecting the configured sound will execute its audible and visual alerts (as pre-configured) 214. Next, the base module detecting the sound will send an outbound trigger message to the gateway system 216, and the gateway system will responsively generate one or more inbound trigger messages 218. These inbound trigger messages could include alerts sent out to the World Wide Web or telephone network (such as SMS messages, emails, actual telephone calls - such as to the fire department). As each remote base module (i.e. that did not directly “hear” the original configured sound) receives the inbound trigger messages 220, they will each execute their local audible and visual alerts (per configuration/programming) 222. As discussed above, an in Z-wave-based HA systems, the remote base modules will then distribute the inbound trigger messages throughout the interconnected HA network 224.

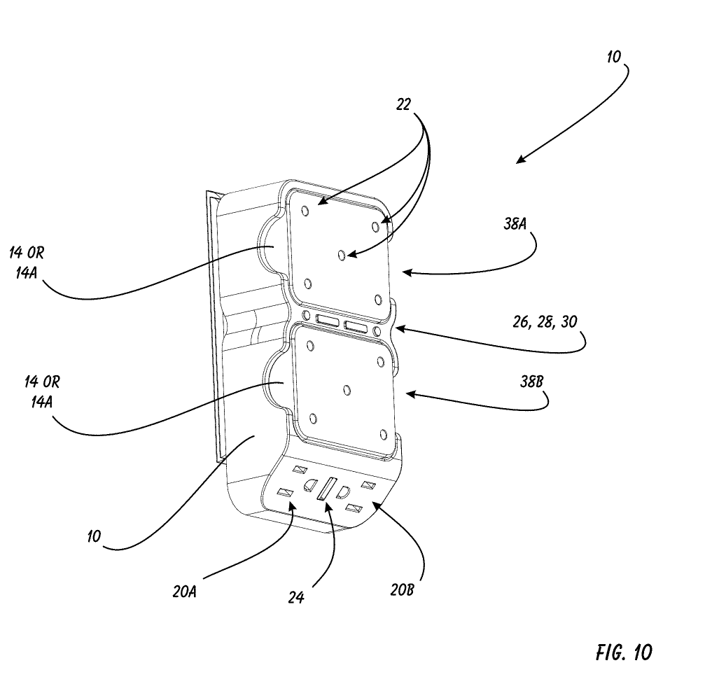

FIG. 10 is a perspective view of an alternate embodiment of the sound-responsive repeater device 10 of the present invention. As can be seen, this version actually mimics the shape of a domino. The purpose of this shape is to reinforce the concept that the cascading operation of the devices 10 can resemble a line of falling dominos.

The base housing 16 provides a pair of holsters 38A, 38B, with each design to accomodate either an interconnected or non-interconnected flashlight module (14A or 14). The modules 14/14A are generally cube-shaped and will pull out away from the base housing 16 in order to be removed. There are outlets 20A, 20B and USB sockets 24 provided on the base housing 16 as well.

The lamps 22 on each module 14/14A are made up of a series of lamp elements that shine through apertures formed in the faces in the modules 14/14A. These lamps 22 could provide the same functionality as that discussed above for the lamps 22 and 42 of the originally-disclosed embodiment of the device 10.

In general, two versions of functionality of the device 10 is planned: an interconnected version and a non-interconnected version. The device 10 can be converted from a non-interconnected version to an interconnected version by replacing a flashlight module 14 with an interconnected flashlight module 14A. As discussed previously, interconnecting the device 10 allows it to communicate with and/or be controlled by a gateway device. Even non-interconnected device 10 are expected to have some of the cascading functionality. This cascading functionality (discussed in previous figures) is likely limited to audible triggers. This means that each device 10 will be able to recognize the audible alert of the another device 10 “out of the box” (i.e. without the user need to enable or program it). For example, the devices 10 could emit a unique tone (or duo-tone) alarm. This unique tone would be designed to be unlikely to be confused with other conventional environmental sounds that the device 10 might “hear.” While different beats or series of tones might be emitted, if these tones are on a pre-determined frequency or dual-tone frequency, then other devices 10 within audible range will be able to recognize both the frequency/frequencies of the tone as well as the beats or spacing. This could lead to the cascaded device 10 being able to repeat the identical audible alert, simply because it recognized the alarm. In other words, different alerts could be set up in one device 10, including the alert priority (e.g. dangerous, warning only, non-safety related, etc.)—the cascading devices 10 will automatically generate the idenical alert without any programming. Of course, in order to have these successive devices 10 set up to recognize the initial audible alarm (e.g. a smoke detector), they would have to be programmed.

Finally, it should be understood that all of the devices 10, whether interconnected or not, can be configured so that they create a trigger based upon voice commands. Because voice commands can be programmed just like any other audible alert (i.e. as a trigger), the devices can be programmed to respond the same as if the configured sound was a machine-generated or organic alert (e.g. breaking glass or doorbell chime).

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A sound repeater device, comprising:
a lamp module;
a base module configured to be plugged into a conventional electrical outlet, said base module further comprising:
a microphone element;
a speaker element; and
a control system, said control system configured to activate said speaker element and said lamp module responsive to a pre-determined sound detected by said microphone element.

2. The device of claim −1, wherein said base module is further defined by a holster configured to removably receive said lamp module therein.

3. The device of claim-1, wherein said lamp module comprises an internal battery, such that a lamp in said lamp module can be illuminated when said lamp module is not within said holster.

4. The device of claim-3, wherein said control system is configured to activate said speaker element and said lamp module responsive to said microphone element detecting a smoke detector alert sound.

5. The device of claim-4, wherein said control system is configured to activate said speaker element and said lamp module responsive to said microphone element detecting a door bell sound.

6. The device of claim-5, wherein said control system is configured to activate said speaker element and said lamp module responsive to said microphone element detecting a pool alert sound.

7. The device of claim-6, wherein said control system is configured to activate said speaker element and said lamp module responsive to said microphone element detecting a flood alert sound.

8. The device of claim-7, wherein said control system is configured to activate said speaker element and said lamp module responsive to said microphone element detecting a carbon monoxide detector alert sound.

9. The device of claim-8, wherein said control system is configured to activate said speaker element and said lamp module responsive to said microphone element detecting a sound emitted by another said sound repeater device.

10. The device of claim-9, wherein said device further comprises a communications system configured to communicate wirelessly with an external communications subsystem.

11. The device of claim-1, wherein said communications system is within said lamp module.

12. A method for repeating a sound, comprising the steps of:
detecting a pre-determined sound at a first device, said pre-determined sound selected from a group of sounds containing a smoke detector alert, a flood detector alert, a doorbell, the sound of glass breaking and a carbon monoxide detecter alert; and
emitting a pre-determined sound at said first device responsive to said first detecting.

13. The method of claim 12, further comprising the step of said first device transmitting a trigger message to a gateway system via wireless communications responsive to said detecting.

14. The method of claim 12, wherein said emitting is further responsive to a unique sound generated by a second said device.

15. The method of claim 12, wherein said emitting is further responsive to receipt of a trigger message wirelessly received from a gateway system.

16. A sound repeater device, comprising:
a base module configured to be plugged into a conventional electrical outlet, said base module further comprising:
an internal battery element
a microphone element;
a speaker element; and
a control system, said control system configured to activate said speaker element and said lamp module responsive to a pre-determined sound detected by said microphone element; and
a lamp module comprising a lamp element and an internal battery, said lamp module attachable to said base module.

17. The device of claim 16, wherein said lamp element of said lamp element is configured to be activated by said base module.

18. The device of claim 16, further comprising a communications system configured to transmit wireless messages responsive to said control system and to receive wireless messages.
